(19) United States
(12) Patent Application Publication
(10) Pub. No.: US 2026/0252368 A1
(43) Pub. Date: Aug. 27, 2026

(54) SYSTEMS AND METHODS FOR LIMITING HOST ACCESS

(71) Applicant: The Bank of New York Mellon, New York, NY (US)

(72) Inventors: Tristan Smith, London (GB); Albert Rodriques, Pennington, NJ (US); Milton Antony Das Augustin Packianathan, Pennington, NJ (US); Tinu Tennyson, Pune (IN)

(21) Appl. No.: 19/062,209

(22) Filed: Feb. 25, 2025

(51) Int. Cl. G06F 9/451; G06F 3/04842; H04L 9/40; H04L 67/08; H04L 67/1396

(52) U.S. Cl. CPC G06F 9/452; G06F 3/04842; H04L 63/101; H04L 63/102; H04L 63/105; H04L 67/08; H04L 67/1396

(57) ABSTRACT

Systems, methods, and computer-readable storage media for emulating a user interface that emulates an interactive server session. In an aspect, the method includes receiving an input indicating user credentials and validating the user to access a viewing tool. The method includes receiving an input indicating a selection of a host for a terminal session to access the viewing tool. The method includes providing a user interface for the viewing tool, the user interface simulating a direct connection to the host in the terminal session. The method includes receiving an input indicating a selection of a command from a set of command options in the user interface, the command associated with one or more operations. The method includes executing the operations on the host using an automation tool and a playbook mapped to the command. The method includes displaying an output of the one or more operations on the user interface.

### TECHNICAL FIELD

The present disclosure generally relates to limiting user access to a server and more particularly to systems and methods for generating a user interface that emulates an interactive server session that limits access to the server via an approved set of commands and defined viewing privileges for the user.

### BACKGROUND

Many industries store data on servers, such as data that may support business operations, services, infrastructure, application assets, and so forth. Such data may be protected and accessed by users authorized to have access. For example, industries may use credential vaulting to securely store and manage sensitive credentials (e.g., passwords, application programming interface (API) keys, etc.) in the secure environment. In some cases, industries may use just-in-time access where authorized users have temporary access to resources, such as servers, for a limited duration (e.g., a period associated with performing a task). In such secure environments, upon authorization, authorized users may access the server via a session. The session may be interactive and provide complete access to the server, such that the user may perform read and write operations. The operations may include inputting commands, browsing files, editing or removing entries (e.g., both read and write privileges), and so forth, since the user is authorized for all interactions.

However, such broad access may not be intended for the particular user. For example, the intended access for the user may be read only privileges rather than both read and write privileges, for example, based on the role of the user within a company. Such broad access may result in unintended actions during the session (e.g., inadvertently delete an entry), resulting in inefficiencies and latencies while rectifying the unintended actions. Additionally, gaining access to the interactive session may be limited to when an incident has occurred. However, gaining access even without an incident occurrence, for example, for viewing data related to the server, may be beneficial.

### SUMMARY

To overcome the challenges described above, aspects of the present disclosure provide systems, methods, and computer-readable storage media for limiting user access to a server and more particularly to systems and methods for generating a user interface that emulates an interactive server session but that limits interactions to an approved set of commands for the user. The method may include receiving, by one or more processors, an input indicating user credentials (e.g., username or other identifier and corresponding password) for accessing a viewing tool (e.g., production viewing tool accessible by a session with a server). The method may include validating, by one or more processors, the user to access the viewing tool based on the user credentials. For example, the method includes validating that the user has permission or is an authorized user to access applications and hosts associated with the viewing tool. The method may include receiving, by the one or more processors, an input indicating a selection of a host for a terminal session, such as a production server, to access the viewing tool for viewing data on the server. In some examples, interactions available to the user in the user interface may be based on the user credentials. For example, file browsing or executing commands in the user interface may be accessible based on privileges associated with the user. Also, the user may gain access to the host even without a trigger, such as a configuration file validation without any occurrence of an incident.

The method may include providing, by the one or more processors, a user interface for the viewing tool (e.g., emulating session that emulates a fully interactive session), where the user interface simulates a direct or fully interactive session with the host in the terminal session.

The method may include receiving, by the one or more processors, an input indicating a selection of a command from a set of command options (e.g., set of commands predetermined based on privileges of the user's and/or the role of the user) in the user interface, where the command is associated with one or more operations. The set of commands available to the user may be based on the user credentials. The user credentials may be indicative of a role of the user within the network. In such examples, the set of commands may include a whitelist of commands for the role. The set of commands may be common to multiple operating systems, such as Windows and Linux.

The method may include determining, by the one or more processors, a quantity of terminal sessions concurrently connected to the host. The method may also include providing, by the one or more processors, the user interface to interact with the host when the quantity of sessions is less than a threshold quantity of sessions concurrently connected to the host (e.g., limit for simultaneous sessions with the host has not been reached). The method may include executing, by the one or more processors, the one or more operations on the host using an automation tool and a playbook mapped to the command. In some examples, executing the one or more operations on the host may include using the direct connection to the host via the automation tool. For example, a connection to the host may be made for performing operations, such as fetching data from the server, and then the data may be presented in the user interface of the emulating session without the user connected to the host.

The operation requests may be polled at an interval (e.g., fixed duration intervals, variable intervals, periodic intervals, etc.) to monitor progress and retrieve results via the automation tool for display in the emulating user interface. The method may include displaying, by the one or more processors, an output of the one or more operations on the user interface. The method may include tracking, by the one or more processors, user activity in the user interface. In such examples, the method may include storing, by the one or more processors, data indicative of the user activity. The method may include validating, by one or more processors, the user for a subsequent request to access the terminal session based on the stored data.

Using the aforementioned features, which are described in more detail below with reference to FIGS. 1-7, restricting user access to a server and generating a user interface that emulates an interactive server session (e.g., where the user access is not restricted), may facilitate in reducing risk of unauthorized access and/or unintended actions that may otherwise occur in a completely interactive session. For example, the user having access to a whitelist or previously approved set of command options may reduce unintended execution of operations on the server since the user does not have privilege to a broader set of commands that may otherwise result in the unintended execution of operations. Limiting user access with respect to browsing files, access files, managing files, and so forth, based on the particular user (e.g., indicated by a role of the user and/or credentials of the user), may also reduce unintended access to privileged data that the user is not authorized to view. Also, by defining the set of command or files accessible to users (e.g., based on particular user or a user role), a repetitive approval process per user or groups of users may be reduced. Reducing the approval process may increase administrative efficiency, as well as resource allocation (e.g., by limiting access to a pool of authorized users rather than a broad group of users).

The set of command options may be the same or common to multiple operating systems, such as Windows and Linux. Such commonality may reduce training overhead that may otherwise occur with different set of commands to learn per operating system. Moreover, the user interface of the emulating session may be similar to or the same as a user interface of a direct connection to the host and/or the interactive session with the host. The similar user interface may provide the user with a familiar and intuitive experience for the user while also implementing securing protocols based on the user (e.g., limited access for the user via set of commands and defined files or folders available for viewing or for requesting data). The set of commands and/or defined files may be reset or redefined, for example, to manage security of the server or as tasks associated with the roles change.

Moreover, in an interactive session, the user may access to the host until the session ends, occupying the host (e.g., resource). The emulating session provides the familiar user interface while making the host available for other users (e.g., that manage the host rather than for retrieving data or for browsing). In particular, an automation tool facilitates operations on the host based on a command from the set of commands when the user executes the command rather than the user occupying the resource when a command is not being executed. Concurrent sessions with the host may also be limited (e.g., below a threshold quantity of sessions) for implementing the emulating session. In this manner, overloading the host with sessions that may result in latencies when providing data, may be reduced. User activity in the emulating session may be tracked and logged. For example, files viewed, duration of viewing files, folders accessed, search requests for files or folders, commands executed, etc., may be logged. The audit trail of logged user activity may be reviewed and facilitate detecting and preventing unauthorized access or malicious actions.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed methods and apparatuses, reference should be made to the embodiments illustrated in greater detail in the accompanying drawings, wherein:

FIG. 1 is a block diagram illustrating an example system for item matching using implicit representation of items in accordance with aspects of the present disclosure.

FIG. 2 is a flow diagram for providing the emulation session in accordance with aspects of the present disclosure.

FIG. 3 is a flow diagram for using the set of commands in the emulation session in accordance with aspects of the present disclosure.

FIG. 4 is an example of a file system view in the user interface of the emulation session in accordance with aspects of the present disclosure.

FIG. 5 is an example of a file view in the user interface of the emulation session in accordance with aspects of the present disclosure.

FIG. 6 is an example of a command executor in the user interface of the emulation session in accordance with aspects of the present disclosure.

FIG. 7 shows a flow diagram of an example method for implementing the emulation session accordance with aspects of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

Server access may be restricted for users using credential vaulting, just-in-time access, or other secured storing techniques. In such secure environments, upon validating user credentials, authorized users may access the server via a session. The session may be interactive and provide full access to the server, such that the user may perform read and write operations. The operations may include inputting commands, browsing files, editing or removing entries (e.g., both read and write privileges), and so forth.

However, such broad access may be broader than intended by administrators for the user. For example, the intended access for the user may be read only privileges rather than both read and write privileges, for example, based on the role of the user. Such broad access may result in unintended actions during the session (e.g., inadvertently delete an entry), resulting in inefficiencies and latencies while rectifying the unintended actions. Additionally, allowing the user that is intended to have access for reviewing some data stored on the server, may inefficiently occupy the server, which may otherwise be used by users intended to have full access (e.g., production users). Moreover, access may be authorized upon an incident occurring but some users may benefit from authorization to access the server without the occurrence of an incident (e.g., users that conduct research on production servers).

As discussed herein, an emulation session may reduce risk of unauthorized access by restricting user interaction in a session to a predefined set of approved commands. The predefined set of approved commands may reduce inadvertent actions (e.g., deleting a file). The emulating session may provide a user interface that is common to various operating systems, such as Windows and Linux, reducing time-consuming training or deployments that are unique to a respective operating system. Emulating the interactive session may also reduce training overhead otherwise associated with learning to navigate in a new user interface.

The techniques discussed herein may also include monitoring, tracking, and logging user activities performed by the user in the user interface of the emulated session. The activity log may be used for subsequent analyzing or reviewing of the user activity, for example, with respect to expected activity. In some examples, reviewing the log may result in subsequent actions. The techniques discussed herein may also include a limit on the quantity of sessions that may occur in parallel (e.g., simultaneously). The emulating session may be provided when the quantity of sessions on the host is below a threshold quantity of sessions. The threshold quantity of sessions may be based on security, for example, to reduce cyberattacks that are more likely to occur when the quantity of sessions on the host exceeds the threshold. For example, the limited quantity of sessions may reduce denial-of-service attacks, as well as balance host usage (e.g., avoid server exhaustion). Moreover, the emulation session that provides limited commands, for example, based on user privileges, may reduce latencies associated with requesting authorization approval, resulting in efficient authorization management and resource allocation.

In particular, the process of implementing the emulating session may include receiving, by one or more processors, an input indicating user credentials (e.g., username or other identifier and corresponding password) for accessing a viewing tool (e.g., production viewing tool). The process may include validating, by one or more processors, the user to access the viewing tool based on the user credentials. For example, the process may include validating that the user has permission or is an authorized user to access applications and hosts associated with the viewing tool. The process may include receiving, by the one or more processors, an input indicating a selection of a host for a terminal session, such as a production server, to access the viewing tool. In some examples, interactions available to the user in the user interface may be based on the user credentials. For example, file browsing or executing commands in the user interface may accessible based on privileges associated with the user.

The process may include providing, by the one or more processors, a user interface for the viewing tool (e.g., emulating session), where the user interface simulates a direct or constant connection to the host in the terminal session (e.g., interactive session with the host, which may be a production server often used by production users). That is, the user interface may emulate the connection with the host so the user feels as if the user is directly connected to the host for complete interaction with the host.

The process may include receiving, by the one or more processors, an input indicating a selection of a command from a set of command options (e.g., set of commands predetermined based on privileges of the user's and/or the role of the user) in the user interface, where the command is associated with one or more operations. The set of commands available to the user may be based on the user credentials. The user credentials may be indicative of a role of the user within the network. In such examples, the set of commands may include a whitelist of commands for the role. The set of commands may be common to multiple operating systems, such as Windows and Linux. To provide flexible access management capabilities, the assignment of user access permissions to different groups of servers may be dynamic (e.g., can be updated or changed) based on various criteria, including application affiliation, geographic location, shared application resources, or the like. Enabling reassignment may facilitate efficient and secure management of access in various different host environments, for example, where assignments of user access privileges may be assigned based on the respective environment of the host.

The process may include determining, by the one or more processors, a quantity of terminal sessions concurrently connected to the host. The process may also include providing, by the one or more processors, the user interface to interact with the host when the quantity of sessions is less than a threshold quantity of sessions concurrently connected to the host (e.g., limit for simultaneous sessions with the host has not been reached). The process may include executing, by the one or more processors, the one or more operations on the host using an automation tool and a playbook mapped to the command. In some examples, executing the one or more operations on the host may include using the direct connection to the host via the automation tool. For example, operation requests may be polled at an interval (e.g., fixed duration intervals, variable intervals, periodic intervals, etc.) to monitor progress and retrieve results via the automation tool for display in the emulating user interface. The process may include displaying, by the one or more processors, an output of the one or more operations on the user interface. The process may include tracking, by the one or more processors, user activity in the user interface. In such examples, the process may include storing, by the one or more processors, data indicative of the user activity. The process may include validating, by one or more processors, the user for a subsequent request to access the terminal session based on the stored data.

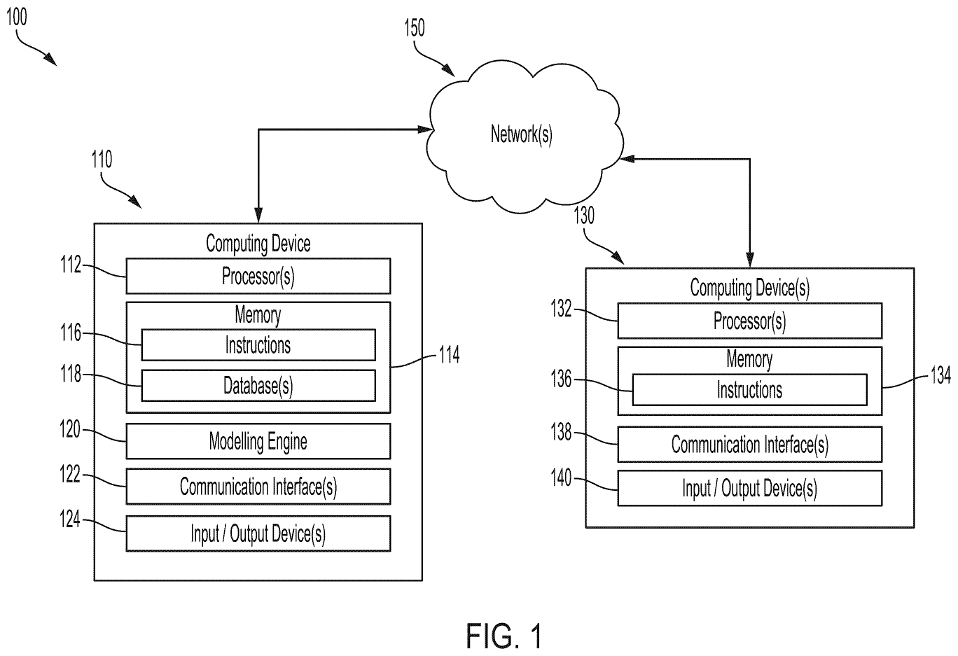

Referring to FIG. 1 a block diagram of a system operating in accordance with aspects of the present disclosure is shown as a system 100. The system 100 includes a computing device 110 configured to receive sets of input data, such as from a computing device 130 via one or more networks 150, and to produce, as output, matched items in a match set. Other outputs may include suggesting items to include in a match set or a ranking of items likely to be in a match set. It is noted that while FIG. 1 is primarily described with reference to functionality provided by computing device 110, it should be understood that the functionality described herein may be provided in a distributed computing environment, such as using a set of computing devices 110, or a cloud-based deployment.

As illustrated in FIG. 1, the computing device 110 includes one or more processors 112, a memory 114, a modeling engine 120, one or more communication interfaces 122, and input/output (I/O) devices 124. The one or more processors 112 may include a central processing unit (CPU), graphics processing unit (GPU), a microprocessor, a controller, a microcontroller, a set of microprocessors, an application-specific integrated circuit (ASIC), an application-specific standard product (ASSP), or any combination thereof. The memory 114 may include read only memory (ROM) devices, random access memory (RAM) devices, one or more hard disk drives (HDDs), flash memory devices, solid state drives (SSDs), other devices configured to store data in a persistent or non-persistent state, network memory, cloud memory, local memory, or a combination of different memory devices. The memory 114 may also store instructions 116 that, when executed by the one or more processors 112, cause the one or more processors 112 to perform operations described herein with respect to the functionality of the computing device 110 and the system 100. The memory 114 may further include one or more databases 118, which may store data associated with operations described herein with respect to the functionality of the computing device 110 and the system 100.

The communication interface(s) 122 may be configured to communicatively couple the computing device 110 to the one or more networks 150 via wired and/or wireless communication links according to one or more communication protocols or standards. The I/O devices 124 may include one or more display devices, a keyboard, a stylus, a scanner, one or more touchscreens, a mouse, a trackpad, a camera, one or more speakers, haptic feedback devices, or other types of devices that enable a user to receive information from or provide information to the computing device 110.

In some examples, the communication interface(s) 122 may provide the emulating session discussed herein. As discussed herein, the emulating session on the computing device 110 may provide limited command options for interacting with the host and may be an interface having a similar user interface as a completely interactive session with the host. The interface may also be common to multiple operating systems, such as Windows and Linux.

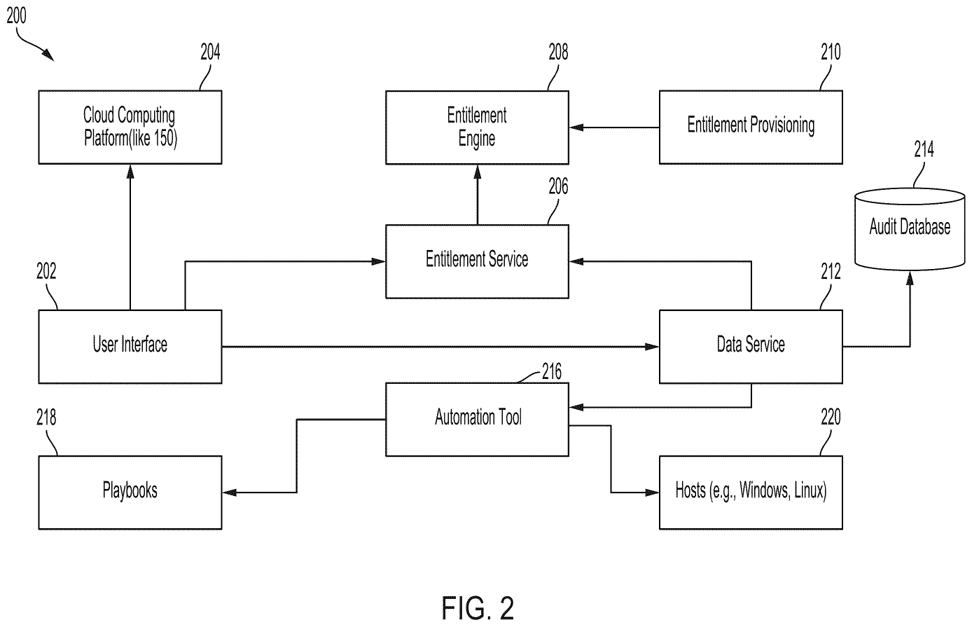

The one or more databases 118 may be configured to store information and/or documents. For example, the one or more databases 118 may include one or more databases storing playbooks that are mapped to one or more commands, as discussed with respect to FIGS. 2-7. For example, upon selection of a command, the mapped playbook may cause an automation tool to execute one or more operations for performing a task associated with the selected command. The playbooks may be different based on the operating system for the emulating session.

The computing device 130 is shown to include one or more processors 112, a memory 134 storing instructions 136, one or more communication interfaces 138, and one or more I/O devices 140. These elements of the computing device 130 may be similar to the corresponding elements of the computing device 110 described above.

Although the following discussions describe the one or more processors 112 as implementing the emulating session, the techniques described herein may be performed, additionally, or alternatively, by the computing device 110 or any components of the computing device 110, or by the computing device 130 or any components of the computing device 130.

For example, the one or more processors 112 may be configured to receive an input indicating user credentials (e.g., username or other identifier and corresponding password) for accessing a viewing tool (e.g., production viewing tool). The one or more processors 112 may validate the user to access the viewing tool based on the user credentials. For example, the one or more processors 112 may validate that the user has permission or is an authorized user to access applications and hosts associated with the viewing tool. The one or more processors 112 may receiving an input indicating a selection of a host for a terminal session, such as a production server, to access the viewing tool. In some examples, interactions available to the user in the user interface may be based on the user credentials. For example, file browsing or executing commands in the user interface may accessible based on privileges associated with the user.

The one or more processors 112 may provide a user interface for the viewing tool (e.g., emulating session), where the user interface simulates a direct or constant connection to the host in the terminal session (e.g., interactive session with the host, which may be a production server often used by production users). That is, the user interface is emulating the direct connection with the host so the user feels as if the user is directly connected to the host.

The one or more processors 112 may receive an input indicating a selection of a command from a set of command options (e.g., set of commands predetermined based on privileges of the user's and/or the role of the user) in the user interface, where the command is associated with one or more operations. The set of commands available to the user may be based on the user credentials. The user credentials may be indicative of a role of the user within the network. In such examples, the set of commands may include a whitelist of commands for the role. The set of commands may be common to multiple operating systems, such as Windows and Linux. In some examples, the set of commands may be based on a global blacklist. The global blacklist may include files, such as encrypted passwords, for all applications. Additionally, maintainer agents may extend the blacklist to include additional or new sensitive files and directories. File listings retrieved may be filtered against this blacklist, preventing the display of blacklisted items.

The one or more processors 112 may determine, by the one or more processors, a quantity of terminal sessions concurrently connected to the host. The one or more processors 112 may provide the user interface to interact with the host when the quantity of sessions is less than a threshold quantity of sessions concurrently connected to the host (e.g., limit for simultaneous sessions with the host has not been reached). The one or more processors 112 may execute the one or more operations on the host using an automation tool and a playbook mapped to the command. In some examples, executing the one or more operations on the host may include using the direct connection to the host via the automation tool. For example, operation requests may be polled at an interval (e.g., fixed duration intervals, variable intervals, periodic intervals, etc.) to monitor progress and retrieve results via the automation tool for display in the emulating user interface. The one or more processors 112 may display an output of the one or more operations on the user interface. The one or more processors 112 may track user activity in the user interface. In such examples, the one or more processors 112 may store data indicative of the user activity. The one or more processors 112 may validate the user for a subsequent request to access the terminal session based on the stored data.

The computing device 110, such as by using the one or more processors 112 of the computing device 110, may be configured to support operations for generating a user interface that emulates an interactive server session but that limits interactions based on a set of approved commands, as discussed in detail with respect to FIGS. 2-7.

FIG. 2 is a flow diagram 200 for for providing the emulation session in accordance with aspects of the present disclosure. The flow diagrams described herein, including the flow diagram 200, may implement aspects of or may be implemented by aspects of the system 100. In the following descriptions of flow diagrams described herein, including the flow diagram 200, the operations performed may be performed in different orders or at different times than the exemplary order shown. Some operations and/or components may also be omitted from the flow diagram 200, or other operations and/or components may be added to the flow diagram 200. The examples described herein are not to be construed as limiting, as the described features may be associated with any quantity of different devices. Although the techniques described herein are described with respect to a session accessing a production server, the techniques may apply to any environment or context involving network resources (e.g., other servers).

The process for providing the emulation session may include a user interface 202 that is accessed by a user. In some examples, the user interface may be for a private production viewing tool (PVT) that has restricted access for authorized users, for example, to manage and/or monitor production servers within the network. The user interface 202 may display an emulation session that emulates an interactive session with a server. For example, the user interface 202 may display an interface similar to or the same one as used for an interactive, direct session.

In an interactive session, the user may have a live or in real-time connection between with the server (e.g., host), where the user may issue commands, access files or other information, run programs, or otherwise perform tasks directly on the server. In some examples, the user may be constantly connected to the host for complete interactions. The server may provide corresponding responses (e.g., to the commands). Accordingly, in an interactive session, the server may be occupied by the session with the user.

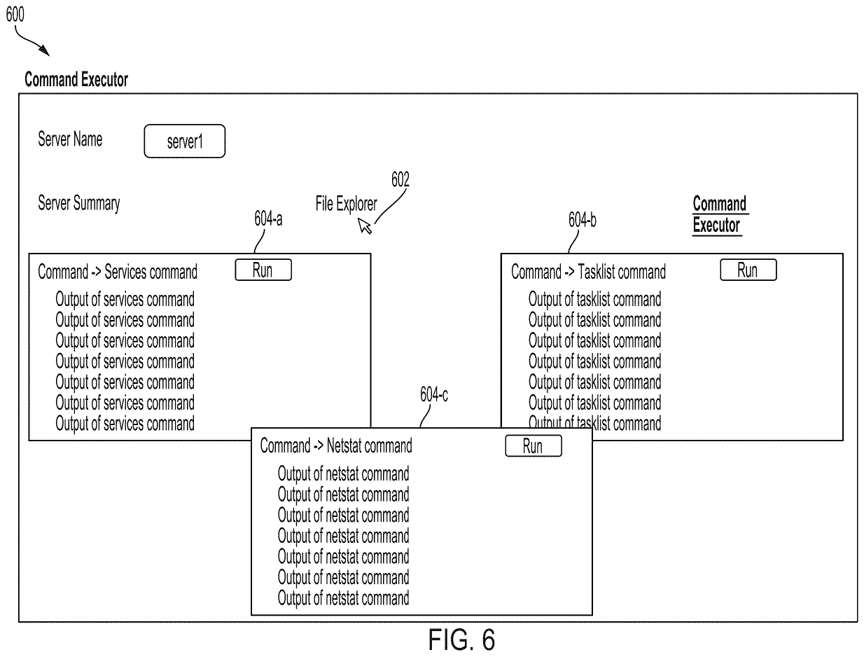

The emulating session may simulate the user interface, behavior, functionality, and/or environment of the interactive session, as if the user is using the native platform of the interactive session. However, rather than having the ability to modify or write to a file accessed via the user interface 202, the authorized user may be limited to selecting a command from a set of commands, as discussed with respect to FIG. 6. The emulating session may restrict browsing and viewing capabilities to defined directories and files, thereby safeguarding sensitive data. The emulating session may also provide flexible access management capabilities, such as by enabling the assignment or reassignment of user access permissions to different groups of servers based on various criteria, including application affiliation, geographic location, and/or shared application resources. This allows for efficient and secure management of access to diverse server environments.

The user may access a cloud computing platform 204. The cloud computing platform 204 may provide cloud-based services, including computing power, storage, databases, networking, machine learning, analytics, and the like. In some examples, the cloud computing platform 204 may be used to deploy and manage application and services, for example, to fetch information from a server using the emulation session. In some examples, the cloud computing platform 204 may be Microsoft Azure or the like.

Upon the user entering credentials at the user interface 202, the credentials may be verified at an entitlement service 206, which may be a PVT entitlement service. The entitlement service 206 may include a service that provides entitlement policies for the viewing tool. The entitlement policies may indicate the rights or permissions granted to a user, application, or device, for example, to access a resource, system, or service. For example, the entitlement service 206 may indicate the access authorization limits associated with the credentials entered at the user interface 202 (e.g., not a production server agent that has read and write access), for example, for accessing a production server.

The entitlement service 206 may use or communicate with an entitlement engine 208 to verify the credentials of the user. The entitlement engine 208 may generally provide a repository of entitlements to assets for one or more users, respectively. In particular, the entitlement engine 208 may be a software, a service, or the like, that automates management, enforcement, and auditing of entitlement of the user, such as the rights or privileges granted to the user for accessing resources. For example, the entitlement engine 208 may indicate the rights to access the server via the emulating session. The entitlement engine 208 may receive the privilege information from execution of an entitlement provisioning process 210. The entitlement provisioning process 210 may include a process where the user is assigned access privileges, as well as access limitations, to the server. The entitlements indicate the resources, systems, and data that the user may access and the operations permitted to be performed by the user. For example, the entitlements may indicate that the user is not a production agent and the privileges assigned include a limited set of commands that may be selected for interacting with the server.

The entitlement service 206 may use or refer to a data service 212. The data service may be a PVT data service, which may be a platform that manages and/or facilitates in providing access to the sensitive or proprietary data in the secured environment. The data service 212 may operate in a private environment, such as one with one or more dedicated servers, a private cloud, and/or an onsite data center. The data service 212 may provide or access tools that can be used for storing data, querying the tools, and/or for analyzing the data. For example, when a user is authorized and inputs commands, gathers data, etc., the activity is logged and may be reviewed. That is, the data service 212 may monitor, log, and review user activities (e.g., time of login, time of logout, commands executed, files or folders accessed, etc.) that occur during the emulating session, and store the logged data in an audit database 214. The logged data may be reviewed to facilitate compliance with policies and/or for maintaining an operational record that may be used for subsequent actions (e.g., add new commands to the set of commands).

The data service 212 may communicate with an automation tool 216 (e.g., automation platform) for automating tasks, for example, using playbooks 218 associated with the automation tool 216. For example, when the user executes a command provided by the data service 212, the command may be mapped to one or more playbooks 218. The playbooks 218 may define a set of automation tasks based on the command, where the command may be associated with managing systems, deploying applications, etc. in the network. A playbook 218 may outline the steps to be performed by the automation tool to execute the requested command. The automation tool 216 may interacts with hosts 220, which may include the server associated with the emulating session. The automation tool 216 may integrate with various technology infrastructures, like different operating systems (e.g., Windows or Linux). As an example, the automation tool may be a Ansible Tower by Red Hat. In some examples, the playbooks 218 may be different based on the operating system of the targeted host. The automation tool 216 may perform the requested command by interacting with the target host 220 for a duration of performing tasks associated with the command, and displaying corresponding information to the user in the emulating session on the user interface 202 that appears to be the same or a similar user interface as if the user is directly interacting with the target host 220 (e.g., an interaction session rather than an emulating session).

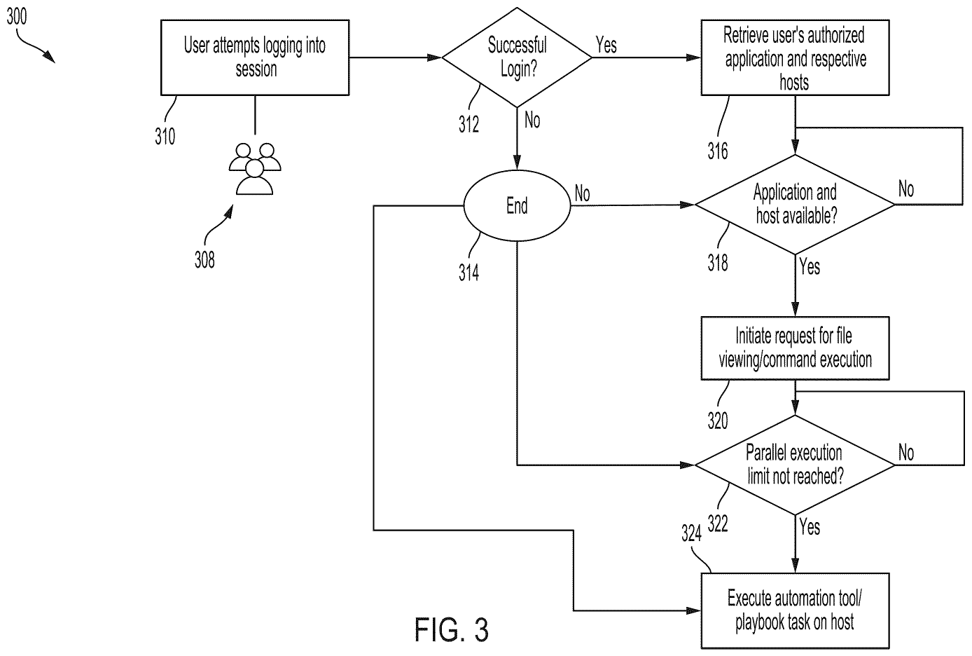

FIG. 3 is flow diagram 300 for using the set of commands in the emulation session in accordance with aspects of the present disclosure. The flow diagrams described herein, including the flow diagram 300, may implement aspects of or may be implemented by aspects of the system 100. In the following descriptions of flow diagrams described herein, including the flow diagram 300, the operations performed may be performed in different orders or at different times than the exemplary order shown. Some operations and/or components may also be omitted from the flow diagram 300, or other operations and/or components may be added to the flow diagram 300. The examples described herein are not to be construed as limiting, as the described features may be associated with any quantity of different devices.

The flow diagram 300 describes a process of using the set of commands in the emulation session. A user 308 may attempt to login to a session at step 310. The session may be an emulating session that emulates the interactive session. For example, the user interface for the sessions may be similar to the user interface for the interactive session. At step 312, the process may include determining whether the login credentials were successful (e.g., perform Multi-Factor Authentication (MFA) for enhanced user security). If the login credentials were not successful, for example, if the password was incorrect for the respective username of the user, then at step 314, the process may end.

However, if the login was successful (e.g., correct credentials), then at step 316, the process may include retrieving the user's authorized application and respective hosts. For example, based on the role of the user, the user may be authorized to access some applications and access to some hosts while other users may not. For example, the user's authorized applications may include applications (e.g., tools, services, etc.) that the user has permission to interact with an entitlement engine, such as entitlement engine 208 of FIG. 2, to access the applications. The entitlement engine may generally manage access control and secure resources, such as the server the user is attempting to access. The user's authorized hosts may include hosts or systems identified in a configuration management database (CMDB) framework. Applications approved by the entitlement engine for the user may interact with hosts identified by the CMDB.

Once the user's authorized applications and respective hosts have be identified, at step 318, the process may include determining whether a selected application and respective host is available. If the application and host are available, then the process proceeds with the user proceeding with a request to view a file or the user may select a command to execute in the emulating session, at step 320. The quantity of concurrent sessions may not exceed a threshold quantity of sessions for a host. Accordingly, at step 322, the process includes checking for available concurrent access to the selected host. If present quantity of sessions has reached the threshold, then the user may be prompted to retry later. However, if the quantity of sessions has not reached the threshold, then the process may proceed with executing the automation tool and playbook task on the host based on the selected command, at step 324. For example, the requested operation by the selected command may be sanitized and executed on the selected host using automation. The response may then be rendered within the user interface. For example, the response may be rendered at the user interface for the user to use for subsequent actions, such as for resolving an incident.

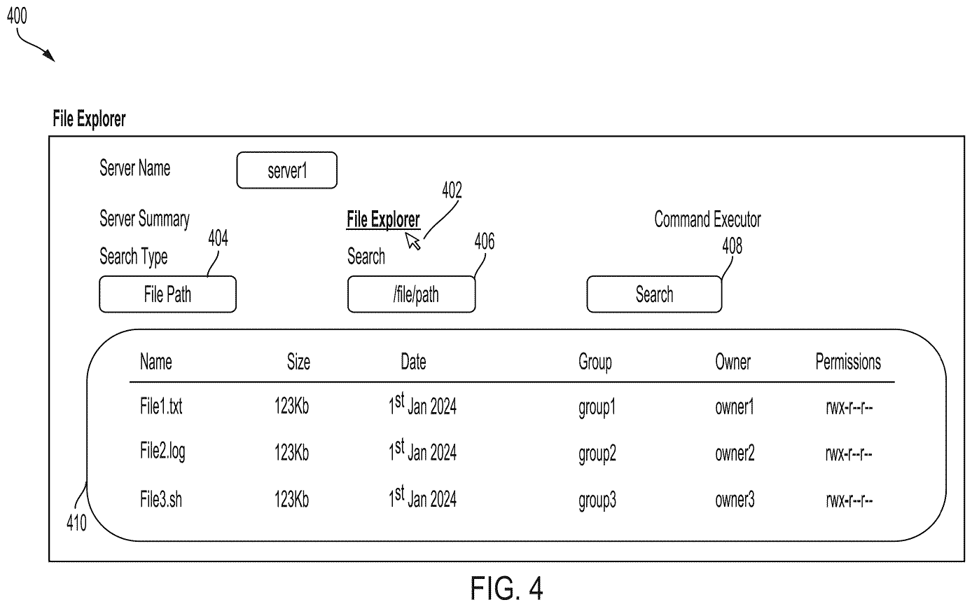

FIG. 4 is an example 400 of a file system view in the user interface of the emulating session in accordance with aspects of the present disclosure. The user interface (e.g., user interface 202 of FIG. 2) of the emulating session may appear similar to or the same as an interactive session where the user may directly interact with the host. The user interface for the file system viewer may display that the user is in a viewing mode. For example, the depicted mode is a “production viewing tool” and thus, the files may relate to production view.

As previously discussed with respect to FIG. 2 and FIG. 3, the user interface may emulate a native interactive server session to provide a familiar and intuitive experience for the user while enforcing security protocols. For example, the user interface may communicate with a file system access control (e.g., associated with the entitlement engine 208 of FIG. 2) that limits browsing and viewing privileges to approved directories and files. As a result, unauthorized disclosure of sensitive data may be reduced. The system may dynamically restrict access based on roles and permissions associated with the user, ensuring a tailored and secure experience for each user. For example, different roles may be associated with different access privileges.

Briefly, and as discussed with respect to FIG. 6, command options presented in the user interface to perform actions while (e.g., in a command executor view) may be limited to an approved set of commands, preventing arbitrary code execution and reducing the risk of unexpected activity. That is, the user interface may display a command whitelist for the user to select commands to be executed, for example, based on roles. Similarly, in the depicted FIG. 4, file viewing access to the file system may be limited. For example, administrators may define files or folders that may not be viewed, for example, based on roles.

To illustrate, in the depicted user interface of the file system viewer, the user may select from various navigation options within the file system viewer. Here, the user has selected 402 (as indicated by the arrow), “file explorer” as the navigation option, to explore files. For a “search type,” within the file explorer, the user may select a “file path” 404 from a set of viewing options (as indicated by a drop-down menu arrow) that the user is authorized to access. The user may search for a particular document within the file path. For example, the user may input the name or other identifier information in an editable field “search” 406 to search within the “file path” 404. The user may execute the search within the file system viewer by selecting a search button 408. The user interface may display the results 410 of the searched information for the file path.

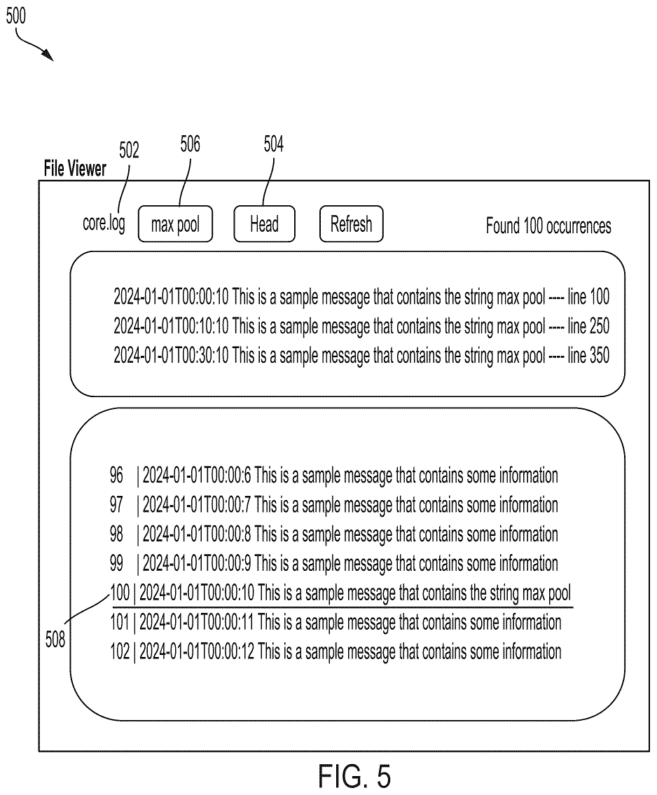

FIG. 5 is an example 500 of a file viewer in the user interface of the emulating session in accordance with aspects of the present disclosure. The user interface for the file viewer may display that the user in a viewing mode, “production viewing tool” and thus, the files may relate to a production view. This view may be similar to or the same as the user interface in an interactive session, as if the user is interacting with the server directly.

The file viewer mode may include an editable field 506 for viewing “core.log” 502. It is noted that core.log 502 has been described by way of illustration, rather than limitation and that other files and file types may be viewed, for example, for further analysis using the concepts described herein. For example, the analysis may be performed with respect to text files or other files containing data relevant to the purpose of the analysis (e.g., extraction of information). The user may input a request in an editable field 506 to search within the “core.log” 502, which may refer to core log files. Core logs may include information about present system operations and incidences.

Here, the user inputs “max pool” in the editable field 506. It is also noted that “max pool” has been described by way of illustration, rather than limitation and that other search parameters may be used, for example, any string content may be searched within a file for further analysis using the concepts described herein. The “max pool” input may refer to a maximum pool size configuration or resource allocation maximum limit. Accordingly, a search for “core.log” files with respect to “max pool” may result in log files that indicate the resource access or requested to access with respect to the max pool size. For example, the search results for the “max pool” within the “core.log” file system may output logs indicating that the max pool was reached. The user may select a command 504 from a set of commands (e.g., via a drop-down menu arrow) that may be executed with respect to the search.

In the depicted example, 100 occurrences of logs indicating the max pool are found. The user selects a log 508 (core.log 100). The selected log 508 may indicate a log that the max pool size was reached when the resource was requested because all pooled connections were in use. For example, the core logs associated with a max pool error may indicate user identification, time, date, requested resource, reason for error (e.g., maximum limit reached), and so forth. Accordingly, the techniques discussed herein may provide a comprehensive view of the max pooled connections, as well as other results from a string content search within a file. Such activities may facilitate in the detection and prevention of unauthorized access. Furthermore, inherent security measures are implemented to prevent denial-of-service attacks by restricting resource consumption (e.g., via the max pool limit).

FIG. 6 is an example 600 of a command executor in the user interface of the emulating session in accordance with aspects of the present disclosure. The user interface (e.g., user interface 202 of FIG. 2) of the emulation session may appear similar to or the same as an interactive session where the user may directly interact with the host. The user interface for the command executor may display that the user in a viewing mode. For example, the depicted mode is a “production viewing tool” and thus, the files may relate to production view.

The command executor may be a tool within the network that runs commands or scripts, for example, as part of automation, management, or deployment processes, often related to servers. Command execution may facilitate in managing resources, orchestrating tasks, and ensuring operations are occurring as excepted. In the depicted user interface of the file system viewer, the user may select from various navigation options within the file system viewer. Here, the user has selected 602 (as indicated by the arrow), “command executor” as the navigation option, to access the command executor. In some example, command executor view may be a command-line interface (CLI). The interface may display one or more command panels 604 that display a panel associated with a respective product. A command panel 604 may display the names of the products and the respective statuses of the products (e.g., a service, a tasklist, etc.).

For example, a first command panel 604-a is associated with services (e.g., “SERVICES”) and displays the names of the various service products and the respective statuses. The output of the depicted services may be saved to a services file. A second command panel 604-b is associated with tasks (e.g., “TASKLIST”) and displays the names of the various images to implement a respective task, process identifier (PID), session names, quantity of sessions, and memory usage. The output of the depicted services may be saved to a task list file. A third command panel 604-c is associated with active connections in the network (e.g., “NETSTAT”) and displays the active connections to the network (“OwningProcess”) along with the local address and/or local port. The connects may include transmission control protocol (TCP) and/or user datagram protocol (UDP) connections. Viewing the active connections may facilitate in identifying applications that are in use or processes that are executing in the network.

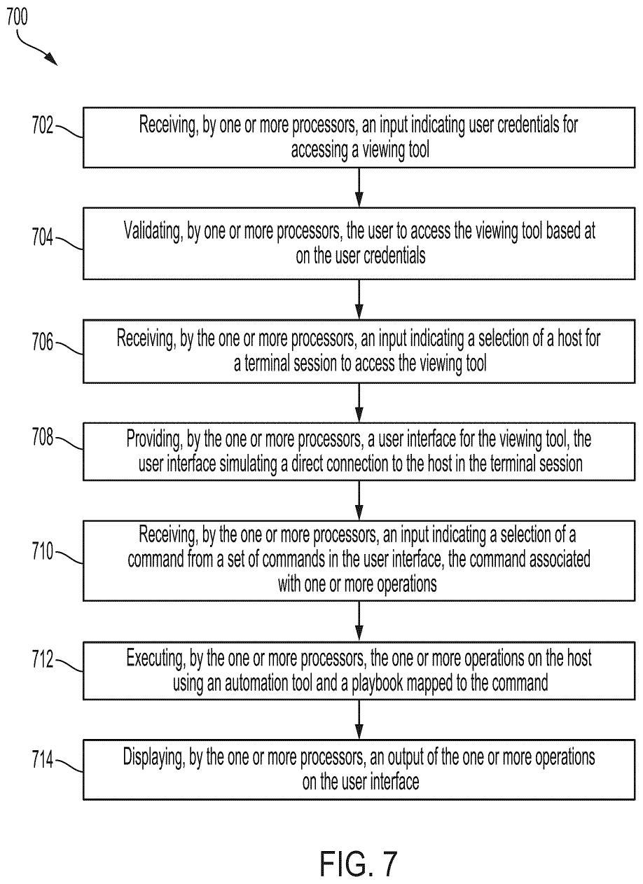

Referring to FIG. 7, a flow diagram for an example method for implementing the emulation session in accordance with aspects of the present disclosure is shown as a method 700. It is noted that the steps or operations described with reference to FIG. 7 are meant to further illustrate aspects of the functionality provided by the one or more modeling engines 120 (e.g., the modeling engine 120 of FIG. 1). Thus, it is to be understood that the functionality described below with reference to the method 700 may be provided by the computing device 110, networks 150, or other types of devices configured to perform the steps of the method 700. The steps or operations of the method 700 may be stored as instructions (e.g., the instructions 116 and/or one or more modeling engines 120) that, when executed by one or more processors (e.g., the one or more processors 112 and/or the one or more modeling engines 120 of FIG. 1), cause the one or more processors to perform the steps of the method 700. It should be understood that the method 700 may be configured to perform various ones of the operations described above with reference to FIGS. 1-6. In the following description of the method 700, the operations performed may be performed in different orders or at different times than the exemplary order shown. Some operations may also be omitted from the method 700, or other operations may be added to the method 700.

At step 702, the method 700 may include receiving, by one or more processors, an input indicating user credentials (e.g., username and password) for accessing a viewing tool (e.g., production viewing tool). The viewing tool may include a production viewing tool and the user may be associated with a non-production role (e.g., non-production agent requesting to view files or request information in a production file system).

At step 704, the method 700 may include validating, by one or more processors, the user to access the viewing tool based on the user credentials. That is, the method includes validating that the user has permission or is an authorized user to applications and hosts associated with the viewing tool. At step 706, the method 700 may include receiving, by the one or more processors, an input indicating a selection of a host for a terminal session to access the viewing tool. In some examples, interactions available to the user in the user interface may be based on the user credentials.

At step 708, the method 700 may include providing, by the one or more processors, a user interface for the viewing tool (e.g., emulating session), where the user interface simulates a direct connection to the host in the terminal session (e.g., direct, interactive session with the host, which may be a production server often used by production users). At step 710, the method 700 may include receiving, by the one or more processors, an input indicating a selection of a command from a set of command options (e.g., set of commands predetermined based on privileges of the user's and/or the role of the user) in the user interface, where the command is associated with one or more operations.

In some examples, the set of commands available to the user may be based on the user credentials. The user credentials may be indicative of a role of the user within the network. In such examples, the set of commands may include a whitelist of commands for the role. The set of commands may be common to multiple operating systems, such as Windows and Linux. For example, the entitled users (e.g., user credentials associated with respective privileges for access) may access a predefined set of approved safe commands on Windows and Linux servers, along with the ability to browse and view files on the servers file system. The files and directories that the user may browse and view may be restricted to prevent sensitive information being disclosed.

In some examples, the method 700 may include determining, by the one or more processors, a quantity of terminal sessions concurrently connected to the host. The method 700 may also include providing, by the one or more processors, the user interface to interact with the host when the quantity of sessions is less than a threshold quantity of sessions concurrently connected to the host. At 712, the method 700 may include executing, by the one or more processors, the one or more operations on the host using an automation tool and a playbook mapped to the command. In some examples, executing the one or more operations on the host may include using the direct connection to the host via the automation tool. For example, operation requests may be polled at an interval (e.g., fixed duration intervals, variable intervals, periodic intervals, etc.) to monitor progress and retrieve results via the automation tool for display in the emulating user interface.

At 714, the method 700 may include displaying, by the one or more processors, an output of the one or more operations on the user interface. In some examples, the method 700 may include tracking, by the one or more processors, user activity in the user interface. In such examples, the method 700 may include storing, by the one or more processors, data indicative of the user activity. The method 700 may include validating, by one or more processors, the user for a subsequent request to access the terminal session based on the stored data. For example, the user activity of a call may be logged pre-execution and post-execution, enabling the system to track in-progress requests. Also, an audit trail of the logged user activities may facilitate in the detection and prevention of unauthorized access or malicious actions.

Although the embodiments of the present disclosure and their advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method, comprising:
receiving, by one or more processors, an input from a user indicating user credentials for accessing a viewing tool associated with a host in a network;
validating, by the one or more processors, authorization of the user to access the viewing tool based at least in part on the user credentials;
receiving, by the one or more processors, an input indicating a selection of the host for a terminal session to access the viewing tool;
providing, by the one or more processors, a user interface for the viewing tool, the user interface simulating a direct connection to the host in the terminal session;
receiving, by the one or more processors, an input indicating a selection of a command from a set of command options in the user interface, the command associated with one or more operations;
executing, by the one or more processors, the one or more operations on the host using an automation tool and a playbook mapped to the command; and
displaying, by the one or more processors, an output of the one or more operations on the user interface.

2. The method of claim 1, further comprising:
determining, by the one or more processors, a quantity of terminal sessions concurrently connected to the host; and
providing, by the one or more processors, the user interface to interact with the host when the quantity of sessions is less than a threshold quantity of sessions concurrently connected to the host.

3. The method of claim 1, further comprising:
tracking, by the one or more processors, user activity in the user interface;
storing, by the one or more processors, data indicative of the user activity; and
validating, by the one or more processors, the user for a subsequent request to access the terminal session based at least in part on the stored data.

4. The method of claim 1, wherein interactions available to the user in the user interface are based at least in part on the user credentials.

5. The method of claim 1, wherein the set of commands available to the user are based at least in part on the user credentials.

6. The method of claim 1, wherein the user credentials are indicative of a role of the user within the network.

7. The method of claim 6, wherein the set of commands comprise a whitelist of commands for the role.

8. The method of claim 1, wherein the set of commands are common to multiple operating systems.

9. The method of claim 1, wherein the viewing tool comprises a production viewing tool and the user is associated with a non-production role.

10. The method of claim 1, wherein executing the one or more operations on the host comprises using the direct connection to the host via the automation tool.

11. An apparatus, comprising:
one or more memories storing processor-executable code; and
one or more processors coupled with the one or more memories and individually or collectively operable to execute the code to cause the apparatus to:
receive an input from a user indicating user credentials for accessing a viewing tool associated with the host in a computing network;
validate authorization of the user to access the viewing tool based at least in part on the user credentials;
receive an input indicating a selection of a host for a terminal session to access the viewing tool;
provide a user interface for the viewing tool, the user interface simulating a direct connection to the host in the terminal session;
receive an input indicating a selection of a command from a set of command options in the user interface, the command associated with one or more operations;
execute the one or more operations on the host using an automation tool and a playbook mapped to the command; and
display an output of the one or more operations on the user interface.

12. The apparatus of claim 11, wherein the one or more processors are individually or collectively further operable to execute the code to cause the apparatus to:
determine a quantity of terminal sessions concurrently connected to the host; and
provide the user interface to interact with the host when the quantity of sessions is less than a threshold quantity of sessions concurrently connected to the host.

13. The apparatus of claim 11, wherein the one or more processors are individually or collectively further operable to execute the code to cause the apparatus to:
track user activity in the user interface;
store data indicative of the user activity; and
validate the user for a subsequent request to access the terminal session based at least in part on the stored data.

14. The apparatus of claim 11, wherein interactions available to the user in the user interface are based at least in part on the user credentials.

15. The apparatus of claim 11, wherein the set of commands available to the user are based at least in part on the user credentials.

16. The apparatus of claim 11, wherein the user credentials are indicative of a role of the user within the computing network.

17. The apparatus of claim 16, wherein the set of commands comprise a whitelist of commands for the role.

18. The apparatus of claim 17, wherein the set of commands are common to multiple operating systems.

19. A non-transitory computer-readable medium storing instructions executable by one or more processors to:
receive an input indicating user credentials for accessing a viewing tool;
validate the user to access the viewing tool based at least in part on the user credentials;
receive an input from a user indicating a selection of a host for a terminal session to access the viewing tool;
provide a user interface for the viewing tool, the user interface simulating a direct connection to the host in the terminal session;
receive an input indicating a selection of a command from a set of command options in the user interface, the command associated with one or more operations;
execute the one or more operations on the host using an automation tool and a playbook mapped to the command; and
display an output of the one or more operations on the user interface.

20. The non-transitory computer-readable medium of claim 19, wherein the viewing tool comprises a production viewing tool and the user is associated with a non-production role.
